(19) United States
(12) Patent Application Publication
(10) Pub. No.: US 2020/0003357 A1
(43) Pub. Date: Jan. 2, 2020

(54) METHOD AND SYSTEM FOR ADAPTIVE GIMBAL

(71) Applicant: SZ DJI OSMO TECHNOLOGY CO., LTD., Shenzhen (CN)

(72) Inventors: Tie Su, Shenzhen (CN); Weidong Li, Shenzhen (CN)

(21) Appl. No.: 16/570,400

(22) Filed: Sep. 13, 2019

Related U.S. Application Data
(63) Continuation of application No. PCT/CN2017/078086, filed on Mar. 24, 2017.

(51) Int. Cl. F16M 11/18; B66C 13/04; F16M 11/12; B64D 47/08; B64C 39/02

(52) U.S. Cl. CPC F16M 11/18; B66C 13/04; F16M 13/04; B64D 47/08; B64C 39/024; F16M 11/12

(57) ABSTRACT

A stabilizing unit includes a frame assembly including a plurality of frame components movable relative to one another and configured to support a payload, a base support coupling the frame assembly to a movable object, one or more inertial sensors attached to the frame assembly or the payload and configured to collect attitude information of the payload, one or more location sensors attached to the base support or one or more frame components and configured to collect location data, one or more actuators configured to control movement of the frame components, and one or more processors configured to control an attitude of the payload based on corrected attitude data by controlling the one or more actuators. The corrected attitude data is calculated based on the attitude information and a horizontal acceleration of the payload that is determined based on the location data.

### CROSS-REFERENCE TO RELATED APPLICATION

This application is a continuation of International Application No. PCT/CN2017/078086, filed Mar. 24, 2017, the entire content of which is incorporated herein by reference.

### BACKGROUND

In many applications, payloads need to be stabilized so that they are not affected by vibrations and unwanted movements. One technology used to stabilize a payload mounted on a movable platform (such as aircrafts, human, vehicle) is active stabilization. Typically, active stabilization systems such as an Inertial Stabilization Platform (ISP) or a gimbal system use motors to counteract any vibration or undesired movements detected by motion sensors. The payload is stabilized by controlling the attitude of the payload supported by the gimbal system. In many cases, attitude information of the payload is used as feedback signal for controlling the gimbal system. Existing approaches for obtaining attitude information may be less than optimal in some instances. For example, when the gimbal itself is in an accelerated motion, the detected attitude information may be inaccurate due to the horizontal movement.

### SUMMARY

Therefore there exists a need for apparatus and methods that can allow a stabilizing platform or a carrier to control attitude of payloads with improved accuracy. A need exists for improved systems and methods to obtain attitude information for the payload based on feedback attitude data. The present disclosure addresses this need and provides related advantages as well.

In one aspect, the present disclosure provides a stabilizing unit for controlling an attitude of a payload. The stabilizing unit may comprise a frame assembly comprising a plurality of frame components movable relative to one another, wherein the frame assembly is configured to support the payload; a base support configured to couple the frame assembly to a movable object or a living subject; one or more inertial sensors attached to the frame assembly or the payload, wherein the one or more inertial sensors are configured to collect attitude information of the payload about a plurality of rotational axes; one or more location sensors attached to (1) the base support, or (2) one or more frame components of the frame assembly, wherein the one or more location sensors are configured to collect location data used for determining a horizontal acceleration of the payload; one or more actuators configured to control movement of the plurality of frame components to control attitude of the payload; and one or more processors, wherein the one or more processors configured to control the attitude of the payload based on corrected attitude data by controlling the one or more actuators, wherein the corrected attitude data is calculated based on the attitude information collected by the one or more inertial sensors and the horizontal acceleration of the payload that is determined based on the location data.

In a related yet separate aspect, a method of using a stabilizing unit to control an attitude of a payload is provided. The method comprises: supporting the payload with aid of: a frame assembly comprising a plurality of frame components movable relative to one another, wherein the frame assembly is configured to support the payload; and a base support configured to couple the frame assembly to a movable object; collecting attitude information of the payload about a plurality of rotational axes with aid of one or more inertial sensors; collecting location data with aid of one or more location sensors attached to (1) the base support, or (2) one or more frame components of the frame assembly, wherein the location data is used for determining a horizontal acceleration of the payload; obtaining a corrected attitude data about the payload, wherein the corrected attitude data is calculated based on the attitude information collected by the one or more inertial sensors and the horizontal acceleration of the payload that is determined based on the location data; and controlling the attitude of the payload based on corrected attitude data by controlling one or more actuators.

In another aspect, a system for controlling an attitude of a payload is provided. The system may comprise: a movable object; stabilizing unit comprising: frame assembly comprising a plurality of frame components movable relative to one another, wherein the frame assembly is configured to support the payload; a base support configured to couple the frame assembly to the movable object; one or more inertial sensors attached to the frame assembly or the payload, wherein the one or more inertial sensors are configured to collect attitude information of the payload about a plurality of rotational axes; one or more location sensors attached to (1) the base support, or (2) one or more frame components of the frame assembly, wherein the one or more location sensors are configured to collect location data useful for determining a horizontal acceleration of the payload; one or more actuators configured to control movement of the plurality of frame components to control attitude of the payload; and one or more processors configured to control the attitude of the payload based on corrected attitude data by controlling the one or more actuators, wherein the corrected attitude data is calculated based on the attitude information collected by the one or more inertial sensors and the horizontal acceleration of the payload that is determined based on the location data.

In some embodiments, the one or more location sensors utilized in the stabilizing unit comprises a GPS unit. The one or more location sensors may be disposed at different locations on the stabilizing unit from the one or more inertial sensors. In some cases, the base support of the stabilizing unit may comprise a handheld support or a mounting assembly. The one or more location sensors are configured to measure a horizontal motion of the payload or the one or more inertial sensors. The horizontal motion may be relative to a ground reference frame. In some cases, the one or more location sensors are configured to detect at least one of a position, linear velocity, linear acceleration of the payload or the one or more inertial sensors.

In some embodiments, the one or more frame components utilized by the stabilizing unit are rotatable relative to one another. The movement of the payload is effected about three axes of rotation by rotating the one or more frame components with aid of the one or more actuators, and the movement of the payload is relative to the base support, and where the three axes of rotation comprise a roll axis, yaw axis, and pitch axis. The attitude of the payload is stabilized with respect to a ground reference frame. In some embodiments, the stabilizing unit further comprising one or more angular positional sensors coupled to the frame components configured to detect an angular position of the one or more actuators for driving the rotational movement of the frame assembly. In some cases, the one or more sensors comprise a magnetic field sensor or an optical encoder. In some cases, the one or more inertial sensors comprise an accelerometer that is attached to the payload or the frame component coupled to the payload. The accelerometer may be configured to measure an attitude angle of the payload about at least a roll axis and a pitch axis relative to a ground reference frame. The accelerometer may be a three-axis accelerometer. In some cases, the attitude information about the payload is determined by measuring a direction of a gravitational vector using the accelerometer and the horizontal acceleration is subtracted from the measured gravitational vector.

In some embodiments the corrected attitude data of the payload is calculated with aid of one or more processors. The one or more processors are on-board the stabilizing unit or remote to the stabilizing unit. In some cases, the corrected attitude data about the payload is determined by (a) measuring a direction of a gravitational vector by a first set of one or more inertial sensors, (b) correcting the measured direction of the gravitational vector with the horizontal acceleration of the payload to obtain a corrected direction of the gravitational vector, and (c) fusing sensor data measured by a second set of one or more inertial sensors with the corrected direction of the gravitational vector. The first set of one or more inertial sensors may include at least an accelerometer and the second set of one or more inertial sensors may include at least a gyroscope or a magnetometer. In some cases, the gravitational vector is measured by an accelerometer. Correcting the attitude data may involve subtracting the horizontal acceleration from the gravitational vector. In some cases, the horizontal acceleration with respect to an accelerometer body reference frame is obtained based on a transformation matrix and a horizontal acceleration measured by the one or more location sensors. In some cases, transformation matrix may be based on a relative movement between the accelerometer and the one or more location sensors measured by one or more angular position or angular motion sensors coupled to the frame assembly. In some cases, an estimated rotation matrix is used to transform the horizontal acceleration to the inertial sensor body reference frame and the estimated rotation matrix is based on one or more angular positional sensors coupled to the frame assembly. In some cases, the one or more inertial sensors include a gyroscope and/or a magnetometer. In some cases, at least one of the filters is used for calculating the attitude data: Kalman filter, extended Kalman filter, and complimentary filter. For example, when a Kalman filter or extended Kalman filter is used, the attitude information from the accelerometer is configured to update an estimation attitude angle provided by the gyroscope and the attitude angle is about at least a pitch axis or roll axis. The attitude information from the accelerometer, gyroscope and magnetometer are weighted to derive the corrected attitude data of the payload. In some cases, each type of sensor data is individually processed by the filter before fused to obtain the corrected attitude data.

In some embodiments, the stabilizing unit is a multi-axis gimbal further comprising one or more angular motion sensors and/or angular positional sensors attached to the frame assembly. One or more processors are individually or collectively configured to determine, based on a target angle, an input torque to be provided from the one or more actuators to the one or more frame components of the gimbal. In some cases, the input torque is determined using a feedback control loop. The feedback control loop is implemented using a proportional-integral-derivative (PID) controller comprising the one or more processors. In some cases, the PID controller is located on-board the gimbal. In examples, the PID controller is configured to determine an input angular velocity based on a difference between the target angle and an angle measured by the one or more motion and/or positional sensors, and/or based on a difference between the input angular velocity and an angular velocity measured by the one or more angular motion sensors and/or angular positional sensors.

In some embodiments, the movable object is selected from the group comprising a UAV, a non-motorized vehicle and a living subject. In some embodiments, the movable object or living subject is not in electrical communication with the stabilizing unit. In some embodiments, the payload comprises an imaging device.

In a separate yet related aspect, the present disclosure provides a method of using a stabilizing unit to control an attitude of a payload. The method may comprise, the method comprising: supporting a payload with aid of: a frame assembly comprising a plurality of frame components movable relative to one another, wherein the frame assembly is configured to support the payload; and a base support configured to couple the frame assembly to a movable object or a living subject; collecting attitude information of the payload about a plurality of rotational axes with aid of one or more inertial sensors; collecting location data with aid of one or more location sensors attached to (1) the base support, or (2) one or more frame components of the frame assembly, wherein the location data is used for determining a horizontal acceleration of the payload; and obtaining a corrected attitude data about the payload, wherein the corrected attitude data is calculated based on the attitude information collected by the one or more inertial sensors and the horizontal acceleration of the payload; controlling movement of the plurality of frame components with aid of one or more actuators, thereby controlling attitude of the payload, wherein the one or more actuators controls the attitude of the payload based on the corrected attitude data.

In another aspect, a stabilizing unit for controlling attitude of a payload is provided. The stabilizing unit comprises: a frame assembly configured to support the payload; one or more inertial sensors configured to collect attitude information of the payload about a plurality of rotational axes; and one or more location sensors removably attached to (1) one or more frame components of the frame assembly, or (2) the payload, wherein the one or more location sensors are configured to collect location data useful for determining a horizontal acceleration of the payload; one or more actuators configured to control an attitude of the payload by actuating the frame assembly, wherein the one or more actuators controls the attitude of the payload based on corrected attitude data, wherein the corrected attitude data is calculated based on the attitude information collected by the one or more inertial sensors and the horizontal acceleration of the payload.

In some embodiments, the one or more location sensors utilized by the stabilizing unit are enclosed in a housing and the housing is releasably coupled to a portion of the one or more frame components of the frame assembly, or the payload. In some cases, the one or more location sensors are configured to transmit the location data wirelessly. In some cases, a power unit is further enclosed in the housing. In some cases, one or more inertial sensors are enclosed in the housing to detect an attitude of the handheld support or mounting assembly. In some embodiments, the one or more location sensors comprise a GPS unit, and the one or more location sensors is at a different location on the stabilizing unit from the one or more inertial sensors. The one or more location sensors are configured to measure a horizontal motion of the payload or the stabilizing unit. The horizontal motion is relative to a ground reference frame. In some cases, the one or more location sensors are configured to detect at least one of a location, linear velocity, linear acceleration of the payload or the stabilizing unit.

In some embodiments, the one or more frame components are rotatable relative to one another and a movement of the payload is effected about three axes of rotation by rotating the one or more frame components with aid of the one or more actuators. In some cases, the movement of the payload is relative to assembly base support, and where the three axes of rotation comprise a roll axis, yaw axis, and pitch axis. In some embodiments, the stabilizing unit further comprising one or more angular positional sensors coupled to the frame components configured to detect an angular position of the one or more actuators for driving the rotational movement of the frame assembly. In some cases, the one or more sensors comprise a magnetic field sensor or an optical encoder. In some cases, the one or more inertial sensors comprise an accelerometer that is attached to the payload or the frame component coupled to the payload. The one or more inertial sensors comprise an accelerometer that is configured to measure an attitude angle of the payload about at least a roll axis and a pitch axis relative to a ground reference frame. The one or more inertial sensors comprise a three-axis accelerometer. The attitude information about the payload is determined by measuring a direction of a gravitational vector using the accelerometer. In some cases, when the payload or the stabilizing unit experiences a linear acceleration, the horizontal acceleration is subtracted from the measured gravitational vector. In some cases, the horizontal acceleration is calculated based on a transformation matrix and a horizontal acceleration measured by the one or more location sensors. In some cases, the transformation matrix is based on relative movement between the one or more inertial sensors and the one or more location sensors measured by one or more angular positional sensors coupled to the frame assembly.

In some embodiments, the movable object is a UAV. The movable object may be an aerial vehicle, a land vehicle, a vehicle traversing water body, a mobile phone, a tablet, a laptop, a wearable device, or a digital camera. In some embodiments, the movable object or living subject is not in electrical communication with the stabilizing unit. In some embodiments, the payload comprises an imaging device.

In a separate yet related aspect, the present disclosure provides a method of using a stabilizing unit to control an attitude of a payload. The method comprising: supporting a payload with aid of: a frame assembly comprising a plurality of frame components movable relative to one another, wherein the frame assembly is configured to support the payload; and collecting attitude information of the payload about a plurality of rotational axes with aid of one or more inertial sensors attached to the frame assembly or the payload; collecting location data with aid of one or more location sensors removably attached to (1) one or more frame components of the frame assembly, or (2) the payload, wherein the one or more location sensors are configured to collect location data useful for determining a horizontal acceleration of the payload; and controlling movement of the plurality of frame components with aid of one or more actuators, thereby controlling attitude of the payload, wherein the one or more actuators controls the attitude of the payload based on corrected attitude data, wherein the corrected attitude data is calculated based on the attitude information collected by the one or more inertial sensors and the horizontal acceleration of the payload

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a block diagram of a stabilizing unit for stabilizing a payload coupled to a movable object, in accordance with some embodiments.

FIG. 2 illustrates an error incurred in an attitude detection using an inertial sensor.

FIG. 3 illustrates exemplary scheme for obtaining payload attitude data using the corrected accelerometer data and gyroscope.

FIG. 4 illustrates a scheme for estimating payload attitude using sensor fusion, in accordance with many embodiments.

FIG. 5 illustrates a scheme of obtaining a corrected attitude data of the payload, in accordance with embodiments of the disclosure.

FIG. 6 illustrates an example of a system for controlling or stabilizing a rotational movement of a payload with respect to one or more axes, in accordance with some embodiments.

FIG. 7 illustrates an example of an apparatus for stabilizing a payload, in accordance with embodiments of the disclosure.

FIG. 8 shows a modular location sensor configured to removably attached to a portion of the frame assembly, in accordance with embodiments of the disclosure.

FIG. 9 illustrates a movable object including a carrier and a payload, in accordance with embodiments.

FIG. 10 is a schematic illustration by way of block diagram of a system for controlling a movable object, in accordance with embodiments.

### DETAILED DESCRIPTION

Systems, methods, and devices are provided for controlling a carrier configured to support a payload. In some embodiments, a payload may be coupled to a movable object (e.g., such as a UAV, human, vehicle) using a carrier that controls an attitude of the payload. The carrier may serve as a stabilizing unit for stabilizing an attitude of the payload by effecting movement of the payload actively. The stabilizing unit may be configured to actively control the attitude of the payload using sensory data as feedback control signals, where the sensory data individually or collectively provide attitude data of the payload with improved accuracy.

In one aspect, a stabilizing unit for controlling an attitude of a payload is provided. In practice, the stabilizing unit may be a carrier. In some embodiments, the stabilizing unit may comprise a gimbal platform. The carrier may comprise a frame assembly comprising a plurality of frame components movable relative to one another, where the frame assembly is configured to support the payload; a base support configured to couple the frame assembly to a movable object or a living subject; and one or more actuators configured to control movement of the plurality of frame components to control an attitude of the payload. The stabilizing unit may further comprise one or more sensors for detecting an attitude data of the payload, and one or more processors configured to control the one or more actuators to change the attitude of the payload based on the attitude data provided by the one or more sensors.

In some cases, movement of the stabilizing unit relative to a reference frame such as ground reference frame may be detected. The detected movement in conjunction with detected attitude information about the payload may be used to obtain a corrected attitude of the payload. For instance, lateral positional or movement of the stabilizing unit may affect inertial sensor data leading to an error in the detected attitude information. Information about such movement may be gathered and used to correct for the attitude data of the payload.

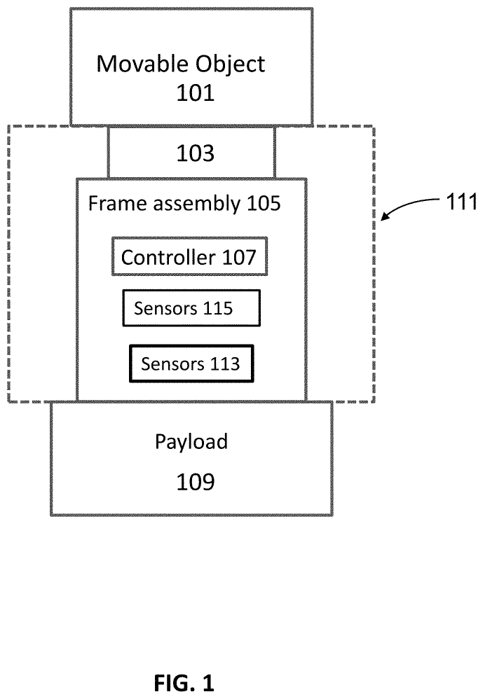

FIG. 1 illustrates a block diagram of a stabilizing unit 111 for stabilizing a payload 109 coupled to a movable object 101, in accordance with some embodiments. The stabilizing unit may comprise a frame assembly 105 comprising a plurality of frame components movable relative to each other. The stabilizing unit may comprise a base support 103 to couple the frame assembly to the movable object or a living subject. One or more rotational movements of the frame components may be actuated by one or more actuators controlled by a controller 107. In some cases, some of all of the frame components experience a horizontal or translational movement. In some cases, the horizontal or translational movement may be accelerated movement. In some embodiments, the controller may comprise one or more processors. In some embodiments, the controller is configured to control an attitude of the payload using attitude data obtained from a plurality of sensors. The plurality of sensors may comprise at least an inertial sensor and a location sensor. In some cases, one or more inertial sensors 113 are attached to the frame assembly or the payload configured to detect attitude information of the payload about a plurality of rotational axes. One or more location sensor 115 may be used to detect a horizontal acceleration of the frame assembly, where the horizontal acceleration may be used to correct the attitude information obtained from the inertial sensors.

The movable object may be live subject such as human or animals, the movable object may be any vehicle such as land vehicle or aerial vehicle. The movable object may be an aerial vehicle, a land vehicle, a vehicle traversing water body, a mobile phone, a tablet, a laptop, a wearable device, or a digital camera. In some cases, the movable object may be in an accelerated motion such that the payload and/or stabilizing unit may experience a linear acceleration with respect to a ground reference frame.

The systems, devices, and methods described herein can be applied to a wide variety of objects. The object can be a movable object. Any description herein may also apply to a static object, such as a tripod. As previously mentioned, any description herein of an aerial vehicle may apply to and be used for any movable object. A movable object of the present disclosure can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; a movable structure or frame such as a stick, fishing pole; or a train), under the ground (e.g., a subway), in space (e.g., a spaceplane, a satellite, or a probe), or any combination of these environments. The movable object can be a vehicle, such as a vehicle described elsewhere herein. In some embodiments, the movable object can be mounted on a living subject, such as a human or an animal. Suitable animals can include avines, canines, felines, equines, bovines, ovines, porcines, delphines, rodents, or insects. The movable object may be the living subject, such as a human or animal that may be carrying the stabilizing unit. the living being may be moving using the living being's own power, or may be riding a vehicle.

The movable object may be capable of moving freely within the environment with respect to six degrees of freedom (e.g., three degrees of freedom in translation and three degrees of freedom in rotation). For instance, the movable object may experience linear acceleration along any direction (e.g., vertical, horizontal or a combination of both) and/or have rotational movement with respect to any rotational axes (e.g., roll, pith, yaw or a combination of any of the axes). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the movable object may be carried by a living being.

In some instances, the movable object can be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

The movable object can be controlled remotely by a user or controlled locally by an occupant within or on the movable object. In some embodiments, the movable object is an unmanned movable object, such as a unmanned aerial vehicle (UAV). An unmanned movable object, such as a UAV, may not have an occupant onboard the movable object. The movable object can be controlled by a human or an autonomous control system (e.g., a computer control system), or any suitable combination thereof. The movable object can be an autonomous or semi-autonomous robot, such as a robot configured with an artificial intelligence.

As described herein, one or more payloads 109 can be supported and controlled/stabilized by the stabilizing unit. A stabilizing unit may be capable of supporting a plurality of different types of payloads. A payload may be coupled to a movable object using the stabilizing unit that controls the position and attitude of the payload. In some instances, the payload can be stabilized using the carrier controlled by an active mechanical control system.

In some embodiments, the payload carried by the stabilizing unit may include one or more imaging devices (including but not limited to video camera or camera) and/or one or more non-imaging devices (including but not limited to microphone, sample collector). The one or more payload devices may be the same type of payload device or different types of payload devices.

Examples of payload devices may include a device that collects data (e.g., imaging device (for visible light, infrared, ultra-violet (UV), geo-thermal or any other type of emission); a device that detects one or more particles; a device that detects a field such as a magnetic field, electric field, radio field; radiation detector; microphone, any type of sensor as described in greater detail elsewhere herein), a device that provides an emission (e.g., light emitter, image emitter, heat emitter, radio emitter, wireless signal emitter particle emitter), a device that interacts with the environment (e.g., robotic arm, sample collector, liquid distributer, pesticide or fertilizer sprayer), or any other type of device or combinations thereof. A payload device can also include one or more sensors for surveying one or more targets. Any suitable sensor can be incorporated into the payload, such as an image capture device (e.g., a camera), an audio capture device (e.g., a parabolic microphone), an infrared imaging device, or an ultraviolet (UV) imaging device. The sensor can provide static sensing data (e.g., a photograph) or dynamic sensing data (e.g., a video). In some embodiments, the sensor provides sensing data for the target of the payload device. Alternatively or in combination, the payload device can include one or more emitters for providing signals to one or more targets. Any suitable emitter can be used, such as an illumination source or a sound source. In some embodiments, the payload device can include one or more transceivers, such as for communication with a module remote from the movable object. Optionally, the payload device can be configured to interact with the environment or a target. For example, the payload device can include a tool, instrument, or mechanism capable of manipulating objects, such as a robotic arm.

In some embodiments, the payload device may include an imaging device configured to acquire and/or transmit one or more images of objects within the imaging device's field of view. Examples of an imaging device may include a camera, a video camera, smartphone/cell phone with a camera, or any device having the ability to capture optical signals. A non-imaging device may include any other devices such as for collecting or distributing sound, particles, liquid, or the like. Examples of non-imaging devices may include a microphone, a loud speaker, a particle or radiation detector, a fire hose, and the like.

Optionally, the payload device may be directed to a field of view. Operation of the payload device may be improved when the field of view can be accurately controlled. In some cases, the payload device may be controlled to be actively stabilized such that jittering and/or undesired movement may be eliminated. In some cases, the payload device may be controlled by a user to have a desired orientation or line of sight. In some cases, the payload device may be controlled for automatically tracking a target.

The payload device may be supported by the stabilizing unit. The stabilizing unit can be provided for the payload device and the payload device can be coupled to the movable object via the stabilizing unit, either directly (e.g., directly contacting the movable object) or indirectly (e.g., not contacting the movable object). In some embodiments, the payload device can be integrally formed with the stabilizing unit. Alternatively, the payload device can be releasably coupled to the stabilizing unit. In some cases, the carrier may be held or released by a living subject. In some embodiments, the payload device can include one or more payload elements, and one or more of the payload elements can be movable relative to the movable object and/or the stabilizing unit.

The stabilizing unit can provide support to the payload device (e.g., carry at least part of the weight of the payload device). The stabilizing unit can include a suitable mounting structure (e.g., a stabilizing gimbal platform) capable of stabilizing and/or directing the movement of the payload device. In some embodiments, the stabilizing unit can be configured to control the state of the payload device (e.g., position and/or orientation) relative to the movable object. For example, the stabilizing unit can be configured to move relative to the movable object (e.g., with respect to one, two, or three degrees of translation and/or one, two, or three degrees of rotation) such that the payload device maintains its position and/or orientation relative to a suitable reference frame regardless of the movement of the movable object. The reference frame can be a fixed reference frame (e.g., the surrounding environment). Alternatively, the reference frame can be a moving reference frame (e.g., the movable object, or a payload target object).

The frame assembly may comprise one or more frame components and a payload support structure coupled to each other. The frame components may be any frame member, connecting member, mounting arm, connecting arm, torsion arm, elongated arm, support frame, etc. that can be used to connect the payload support structure to a movable object. In other cases, the frame member may have any form factor such as spherical rotor of a spherical motor. The carrier component may be configured to connect the payload support structure and/or the payload to the movable object, for example as shown in FIG. 1.

In some embodiments, the stabilizing unit can be configured to permit movement of the payload device relative to the stabilizing unit and/or the movable object. The movement can be a translation with respect to up to three degrees of freedom (e.g., along one, two, or three axes) or a rotation with respect to up to three degrees of freedom (e.g., about one, two, or three axes), or any suitable combination thereof. The movement of the payload may be a stabilized movement without undesired vibration/jittering or movement caused by the movable object or any external disturbance. The movement of the payload may be a controlled movement relative a fixed reference frame such as auto-tracking of a target relative to a ground reference frame.

A stabilizing unit, such as a camera mount or a gimbal mount, may be provided for supporting and stabilizing one or more payload devices. The stabilizing unit may comprise a carrier including a frame assembly configured to hold the payload device, a motor assembly, a controller assembly, and/or a base support.

The stabilizing unit may comprise a controller assembly that comprises a sensing system and a controller 107. In some cases, the sensing system may be configured to detect or obtain state information associated with the payload device. The state information may include velocity, orientation, attitude, gravitational forces, acceleration, position, and/or any other physical state experienced by the payload device. For example, the state information may include an angular and/or linear position, velocity and/or acceleration, (which may include an orientation or inclination of the payload device).

In some embodiments, the sensing system may include a plurality of sensors 113, 115. In some cases, the plurality of sensors may include one or more inertial sensors 113 and one or more location sensors 115. In some cases, sensory data collected from the location sensor may be used to correct the attitude data measured by the inertial sensor to achieve an improved accuracy of attitude measurement. The plurality of sensors may include at least an inertial measurement member comprising one or more gyroscopes, velocity sensors, accelerometers, magnetometers, and one or more location sensors. The inertial sensor may be used for obtaining data indicative of a spatial disposition (e.g., position, orientation, angle) and/or motion characteristic (e.g., translational (linear) velocity, angular velocity, translational (linear) acceleration, angular acceleration) of a payload. An inertial sensor may be used herein to refer to a motion sensor (e.g., a velocity sensor, an acceleration sensor such as an accelerometer), an orientation sensor (e.g., a gyroscope, inclinometer), or an IMU having one or more integrated motion sensors and/or one or more integrated orientation sensors. An inertial sensor may provide sensing data relative to a single axis of motion. The axis of motion may correspond to an axis of the inertial sensor (e.g., a longitudinal axis). A plurality of inertial sensors can be used, with each inertial sensor providing measurements along a different axis of motion. For example, three angular accelerometers can be used to provide angular acceleration data along three different axes of motion. The three directions of motion may be orthogonal axes. One or more of the angular accelerometers may be configured to measure acceleration around a rotational axis. As another example, three gyroscopes can be used to provide orientation data about three different axes of rotation. The three axes of rotation may be orthogonal axes (e.g., roll axis, pitch axis, yaw axis). Alternatively, at least some or all of the inertial sensors may provide measurement relative to the same axes of motion. Such redundancy may be implemented, for instance, to improve measurement accuracy. Optionally, a single inertial sensor may be capable of providing sensing data relative to a plurality of axes. For example, an IMU including a plurality of accelerometers and gyroscopes can be used to generate acceleration data and orientation data with respect to up to six axes of motion. In some embodiments, one or more inertial sensors 113 may be located to the frame assembly or the payload.

In some embodiments, the attitude data collected by the IMU may be corrected by data collected from the one or more location sensors. The one or more location sensors may include a variety of suitable sensors capable to measure a location of the stabilizing unit or payload with respect to a reference frame such as a ground reference frame. The location relative to the ground reference frame may be along any direction such as in the horizontal plane or in a vertical direction. The location sensors may include, for example, global position system (GPS), vision sensors, proximity sensors, etc. The location may be obtained from the direct sensory data such as using a GPS. The location may be obtained by measuring a distance relative a reference object such as using the proximity sensors. The location may be obtained by reconstructing world coordinates of the sensor by analyzing image data of a reference object such as using the vision sensors. In some cases, the sensory data collected from the location sensors may be used to obtain a linear acceleration along the related direction. In some cases, the linear acceleration may be obtained by one or more steps to process the sensory data. For instance, when the location data is collected using a GPS, a linear acceleration may be obtained by taking derivative of the detected location or linear velocity over a period of time.

One or more location sensors 115 may be located on the stabilizing unit. The one or more location sensors may be, for example, located on a frame component or any structure of the frame assembly. The one or more location sensors may locate at a different location on the stabilizing unit from the one or more inertial sensors. Optionally, one or more location sensors 115 may be located with the inertial sensors. In some embodiments, the one or more location sensors may be located on the same frame component to which the inertial sensors are attached. In some cases, the location sensors may be located on different frame component from the inertial sensors, such that the inertial sensors may have rotational movement relative to the location sensors. In some cases, the rotational movement may be about a roll and/or pitch axis. The relative rotational movement may not result in a significant discrepancy in the horizontal linear velocity between the inertial sensors and the location sensors. In some cases, a linear acceleration of the one or more inertial sensors can be derived based on the linear acceleration measured by the location sensors using a transformation matrix. The transformation matrix may be obtained based on a known geometric or kinematics relationship (e.g., length of frame component, joint angle, etc) between the inertial sensors and the location sensors. Details regarding the plurality of sensors are described later herein.

The controller assembly may also include a controller 107 for calculating posture information associated with the payload device based on the state information obtained by the sensing system. For example, detected angular velocity and/or linear acceleration of the payload device may be used to calculate the attitude of the payload device with respect to a pitch, roll and/or yaw axis of the payload device. The controller may be configured to obtain additional information such as information about a lateral movement of the stabilizing unit or the payload. The controller may be configured to calculate a linear acceleration of the stabilizing unit. The linear acceleration may be in a horizontal or lateral plane. In some cases, the lateral or horizontal acceleration may be used to correct for the detected attitude data of the payload device.

Based on the calculated posture of the payload device, one or more motor signals may be generated to control the motor assembly. The motor assembly may be configured to directly drive the frame assembly to rotate around at least one or a pitch, roll or yaw axis of the payload device so as to adjust the posture of the payload device (e.g., the shooting angle of an imaging device). In some embodiments, the motor assembly can comprise one or more actuators that are configured to actuate one or more components of the frame assembly to move about one or more rotational axes. One or more actuators may comprise one or more motors. A variety of motors may be used such as stepper motor, brushless DC motor, brush DC motor, DC servo motor, etc. In some embodiments, one or more of the rotational axes (e.g., pitch, roll and yaw) may intersect with the payload device.

In some embodiments, the frame assembly may comprise a plurality of frame components that the rotation order of the payload device is selected to allow the payload device to be rotated without the problem of “gimbal lock” under ordinary operational circumstances for the payload device, such as when pointing straight down. For example, in one embodiment, the rotation order may be pitch, roll and yaw from the innermost to outermost rotational axis. In another embodiment, the rotation order may be pitch, roll and yaw from the outermost to the innermost rotational axis. Any rotation order (e.g., pitch/yaw/roll, roll/pitch/yaw, roll/yaw/pitch, yaw/roll/pitch, or yaw/pitch/roll from outermost to the innermost rotational axis, or from innermost to outermost rotational axis) of the payload device may be contemplated. In some embodiments, the frame assembly may comprise a spherical actuator in which case the spherical actuator may move the payload support about up to three rotational axes.

In some embodiments, controlling the carrier may comprise effecting movement of the carrier based in part on a feedback signal. The feedback signal may contain attitude data about the payload. In some embodiments, the movement of the carrier may comprise an angular position, an angular velocity, an/or an angular acceleration of the carrier with respect to one or more axes.

The carrier frame assembly can include individual carrier frame components, some of which can be movable relative to one another. The carrier actuation assembly can include one or more actuators (e.g., motors) that actuate movement of the individual carrier frame components. The actuators can permit the movement of multiple carrier frame components simultaneously, or may be configured to permit the movement of a single carrier frame component at a time. The movement of the carrier frame components can produce a corresponding movement of the payload. For example, the carrier actuation assembly can actuate a rotation of one or more carrier frame components about one or more axes of rotation (e.g., roll axis, pitch axis, or yaw axis). The rotation of the one or more carrier frame components can cause a payload to rotate about one or more axes of rotation relative to the movable object. Alternatively or in combination, the carrier actuation assembly can actuate a translation of one or more carrier frame components along one or more axes of translation, and thereby produce a translation of the payload along one or more corresponding axes relative to the movable object.

The carrier can be integrally formed with the movable object. Alternatively, the carrier can be releasably coupled to the movable object. The carrier can be coupled to the movable object directly or indirectly. The carrier can provide support to the payload (e.g., carry at least part of the weight of the payload). The carrier can be a suitable mounting structure (e.g., a gimbal platform) capable of stabilizing and/or directing the movement of the payload. In some embodiments, the carrier can be adapted to control the state of the payload (e.g., position and/or orientation) relative to the movable object. The carrier can be rotatably coupled to the movable object (e.g., via a rotatable joint or connection) so as to rotate relative to the movable object about one or more rotational axes. For example, the carrier can be configured to move relative to the movable object (e.g., with respect to one, two, or three degrees of translation and/or one, two, or three degrees of rotation) such that the payload maintains its position and/or orientation relative to a suitable reference frame regardless of the movement of the movable object. The reference frame can be a fixed reference frame (e.g., the surrounding environment). Alternatively, the reference frame can be a moving reference frame (e.g., the movable object, a payload target). For instance, the moving reference frame may be used to specify a movement relative to the payload target for autonomous tracking.

In some embodiments, the stabilizing unit may comprise a base support 103 to couple the frame assembly to a movable object or a living subject as described previously. The base support may be located on or carried by at least one selected from the following: a movable object, a stationary object, or a living subject. In some cases, the movable object may comprise an aerial vehicle, a land-based vehicle, or a handheld mount.

In some embodiments, the base support may comprise a handheld support configured to allow the stabilizing unit be carried by a movable object. For example, the handheld support may allow a human being to carry the stabilizing system where. The handheld support may comprise any shape or structure for a human being to grasp or hold. The structure may be ergonomic. The handheld support may comprise single or multiple handles. The handheld support may permit a human being to carrier or hold the stabilizing unit from a variety of locations relative to the payload such as above, below, or behind the payload. The human being who is holding the handheld support may or may not be in motion. In another example, the handheld support may permit the stabilizing unit to be carried by a motorized or non-motorized vehicle such as a bicycle. The vehicle may be in a motion with a wide range of acceleration rate. In some cases, the handheld support may not comprise coupling means to attach the stabilizing unit to the movable object. In some cases, the handheld support may comprise coupling means without requirement of tools for attaching the stabilizing unit to the movable object. When the stabilizing unit is carried by the movable object via the handheld support, there may or may not be relative movement between the handheld support and the movable object.

In some embodiments, the base support may comprise a mounting assembly. The mounting assembly may enable the stabilizing unit to be coupled to a vehicle having a complimentary portion for accepting the mounting assembly. In some cases, coupling via the mounting assembly may not require use of tools. In some cases, once coupled, the mounting assembly may be fixed relative to the coupled movable object. In other cases, the mounting assembly may be allowed to move such as rotate about a yaw axis relative to the coupled movable object.

As described previously, the movable object may be capable of moving freely within the environment with respect to six degrees of freedom (e.g., three degrees of freedom in translation and three degrees of freedom in rotation). In some cases, the motion may have a linear acceleration along a ground surface. For instance, a horizontal location of the movable object may be changing with respect to time. An accelerated motion of the movable object may cause undesired movement of the payload. In some instances, when the movable object has a horizontal acceleration rate, the payload carried by the movable object is also subject to the accelerated movement. In such case, an error may incur in the attitude data about the payload collected by inertial sensors. This attitude error may cause the payload having a wrong attitude such as undesired tilting. The provided method and stabilizing unit is able to correct this error thus providing improved stabilization and attitude control of the payload.

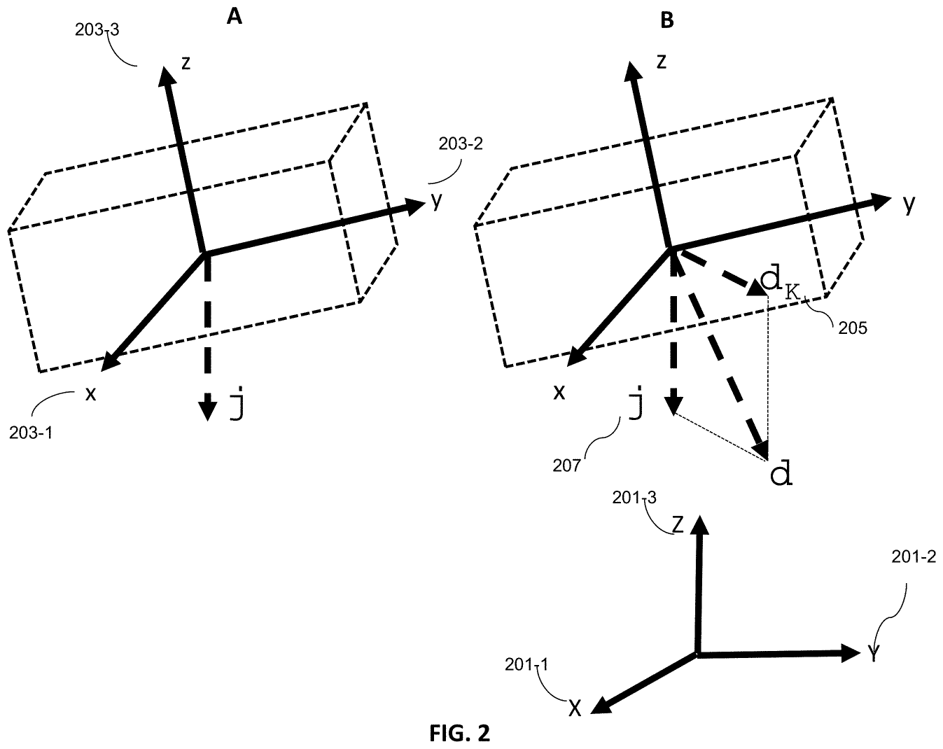

FIG. 2 illustrates an error incurred in an attitude detection using an inertial sensor. In some embodiments, the inertial sensor used for detecting an attitude angle of the payload is an accelerometer. In some cases, the accelerometer is a three-axis accelerometer. The accelerometer may be mounted on the payload or attached to any portion of the payload. The accelerometer may be attached to a portion of the frame assembly. In some cases, the accelerometer has the same rotational movement as the payload. The accelerometer is sensitive to both linear acceleration and the local gravitational field.

In some cases, the attitude information about the payload may be determined by (a) measuring a gravitational vector g, and the gravitational vector is corrected by a horizontal acceleration of the payload a_{H}; and (b) fusing the sensor data measured by the one or more inertial sensors with (a).

The accelerometer is able to measure an orientation of the sensor in an earth gravitational field. The orientation angle with respect to the earth/world gravitational field can be obtained by a rotation matrix from the ground reference frame to the accelerometer sensor body frame. The measurement may be based on a measure of a difference between an acceleration vector in the sensor's body frame and the gravitational vector. In some cases, the readout data of the accelerometer a may be based on the assumption that the sensor is experiencing a gravitational acceleration g. Therefore, it is critical to resolve the gravitational acceleration from the total linear acceleration experienced by the accelerometer.

As shown in FIG. 2, reference frame XYZ may represent a ground reference frame. For instance, axis Z 201-3 may be aligned with earth gravitational field, and axis X 201-1 and axis Y 201-2 may define a horizontal plane. In some cases, axis Z 201-3 may represent a rotational axis such as a yaw axis, axis X and axis Y may represent roll and pitch axes respectively.

Frame xyz (201-1, 201-2, 201-3) may represent accelerometer's body frame. A rotation matrix R between the ground reference frame XYZ and the body frame xyz may be introduced to describe an orientation of the accelerometer with respect to ground reference frame. In situation A, when the accelerometer has no acceleration vector component in the horizontal plane as defined by the world frame, the acceleration vector measured by the accelerometer is gravitational vector g or acceleration aligned with the gravitational vector direction. In this case, the readout of the accelerometer may be represented by

$$[ \begin{matrix}Gx \\ Gy \\ Gz\end{matrix} ] = R [ \begin{matrix}0 \\ 0 \\ g\end{matrix} ]$$

wherein the readout may be measured in any suitable unit, when the unit for example is g, g may be normalized to 1 in the right-hand side. Gx, Gy and Gz represents readout in the xyz body frame. In some cases, rotation angle about yaw axis may not be used.

The rotation matrix R can be resolved and a rotational angle about roll axis and pitch axis (e.g., 201-1 and 201-2) can be obtained. In situation B, when the accelerometer has linear acceleration component such as a_{H} 205 not aligned with the gravitational direction (e.g., 201-3), the readout of the accelerometer may be presented by the equation below:

$$[ \begin{matrix}Gx \\ Gy \\ Gz\end{matrix} ] = R [ \begin{matrix}0 \\ 0 \\ g\end{matrix} ] - R [ \begin{matrix}{a}_{x} \\ {a}_{y} \\ {a}_{z}\end{matrix} ] \\ [ \begin{matrix}{a}_{x} \\ {a}_{y} \\ {a}_{z}\end{matrix} ] = T [ \begin{matrix}{a}_{x}^{′} \\ {a}_{y}^{′} \\ {a}_{z}^{′}\end{matrix} ]$$

where aₓ, a_{y}, and a_{z} represents a linear acceleration of the accelerometer, aₓ and a_{y} are the components of the horizontal acceleration a_{H} 205 in X 201-1 and Y axis 201-2 direction respectively, a′ₓ, a′_{y}, and a′_{z} represents a linear acceleration measured by one or more sensors (e.g. GPS). a_{g} 207 represents the component in the gravitational field direction, R represents a rotation matrix from the ground reference frame to the accelerometer body frame. T represents a transformation matrix from the linear acceleration measured by the one or more sensors to the acceleration of the accelerometer. T may depend on one or more relative rotational movement and dimension information (e.g. frame length) between the sensors (e.g. GPS) and the accelerometer. In some cases, the relative rotational movement can be obtained from one or more rotational sensors attached to the frame component. The dimension information may be pre-determined and known to the system. Please note the above equation is for illustration purpose, the form of the equation may vary depend on the representation of reference frame, measurement unit, etc.

In situation B, an error may occur if we do not account for the linear acceleration. In some cases, the linear acceleration may be estimated by a horizontal acceleration. The horizontal acceleration is needed to eliminate the effect of the horizontal forces. The horizontal acceleration may be used as correction terms for the gravitational force. In some cases, the readout of the accelerometer may be in the unit of g, it is critical to resolve the gravitational acceleration from the horizontal acceleration. In some cases, the horizontal acceleration may be subtracted from the output data of the accelerometer before calculation of the attitude angle. To resolve the correct rotation angle about roll and pitch axes (e.g., 201-1 and 201-2) from the rotation matrix R, the horizontal acceleration a_{H} 205 (i.e. aₓ and a_{y}) is needed. The readout from the accelerometer (Gx,Gy,Gz) may be accounted for the horizontal acceleration a_{H} before used to compute the rotational angle about roll and pitch axes from the rotation matrix R between the accelerometer body frame and the inertial frame. The one or more location sensors may or may not move relative to the one or more accelerometers.

In some embodiments, the horizontal acceleration is obtained by measuring a horizontal position and/or velocity. The horizontal acceleration can be obtained by one or more location sensors. In some cases, the location sensor may be a global position system (GPS). Various technologies may be employed to improve precision of GPS measurement such as real time kinematics (RTK). Horizontal movement of the payload can be measured by the GPS. The horizontal movement detected by the GPS may include at least a linear velocity in the horizontal plane or location of the payload in the horizontal plane. The data measured by GPS may be further processed to obtain a horizontal acceleration. For example, a first order derivative of the velocity or a second order derivative of the location in x and y direction may provide the acceleration a_{H} 205 in the x and y direction (i.e. aₓ and a_{y}). In this case, the transformation matrix T should be updated to represent the relative movement between the reference frame of the measured horizontal acceleration and reference frame of the accelerometer.

Other suitable location sensors can also be used to obtain the acceleration in the horizontal plane. Any suitable sensors may also be used to obtain the horizontal acceleration. For example, motion sensors such as IMU or vision sensors such as binocular vision sensors or monocular visual odometry may also be used to obtain the horizontal acceleration. The location sensor may or may not need to communicate with external object such as satellite. In some cases, the horizontal acceleration may be calculated based on location data captured during a period of time such as using a GPS. In some cases, the horizontal acceleration may be obtained directly from the sensor such as using an accelerometer. In some cases, one or more sensors may comprise any suitable sensor that is capable to measure a horizontal linear velocity, location or linear acceleration of the payload. For instance, instead of GPS, motion sensors such as IMU or vision sensors such as binocular vision sensors or monocular visual odometry (MVO) may be used to obtain the horizontal acceleration. Optionally, two or more sensors may be used collectively to produce the horizontal acceleration. For instance, a fusion of GPS data and visional sensors data or IMU data may be used to produce the horizontal acceleration. In another instance, more than one GPS units may be used to measure the horizontal velocity. In some cases, at least a portion of the sensors configured to detect a horizontal movement (e.g., location, velocity) of the payload are enclosed in the housing, whereas the rest of the sensors may be located at a different location. For instance, when two GPS are used to produce, one of the GPS may be enclosed in the housing and the other GPS may be provided on the payload or on the movable object/living subject. In some cases, when two or more different types of sensors are configured to provide a horizontal acceleration, the sensor data may be cross-checked for validity or quality before being fused to calculate the horizontal acceleration.

In some embodiments, when a location sensor such as GPS is used to measure the horizontal acceleration, the transformation matrix T may be required to transform the linear horizontal acceleration to the acceleration of the accelerometer in the accelerometer body frame. The GPS may or may not move relative to the accelerometers. The location sensor (e.g., GPS) and the inertial sensor may or may not have different horizontal acceleration. In some cases, the location sensor and the inertial may have different horizontal acceleration in which case a transformation matrix may be used. T represents a transformation matrix from the linear acceleration measured by the GPS to the acceleration of the accelerometer. T may depend on one or more relative rotational movement and dimension information (e.g. frame length) between the GPS and the accelerometer. In some cases, the relative rotational movement can be obtained from one or more rotational sensors attached to the frame component. The dimension information may be pre-determined and known to the system. In some cases, one or more rotational sensors may be used to detect an angular position. The one or more rotational sensors may comprise a magnetic field sensor or an optical encoder. For example, rotational sensors such as encoders may be used to detect a relative angular position of the frame component relative to each other in the frame assembly, and the rotational relationship together with the dimension information may be used to derive the transformation matrix. Various other sensors such as gyroscope or IMU can also be used to obtain the transformation matrix.

In some embodiments, the location sensor (e.g. GPS) and the inertial sensor (e.g., accelerometer) may have substantially the same translational acceleration, in which case the transformation matrix may represent a rotation from an initial reference frame (e.g., ground reference frame) to the current orientation of the inertial sensor/payload. In some cases, the matrix may be estimated based on one or more angular positional or angular motion sensors coupled to the frame assembly. The angular positional sensors may comprise at least a magnetic field sensor or an optical encoder. The angular positional or angular motion sensor may be the same rotational sensors as described previously.

In some cases, the attitude information about the payload may be determined by (a) measuring a gravitational vector, and the gravitational vector is corrected by a horizontal acceleration of the payload; and (b) fusing the sensor data measured by the one or more inertial sensors with (a).

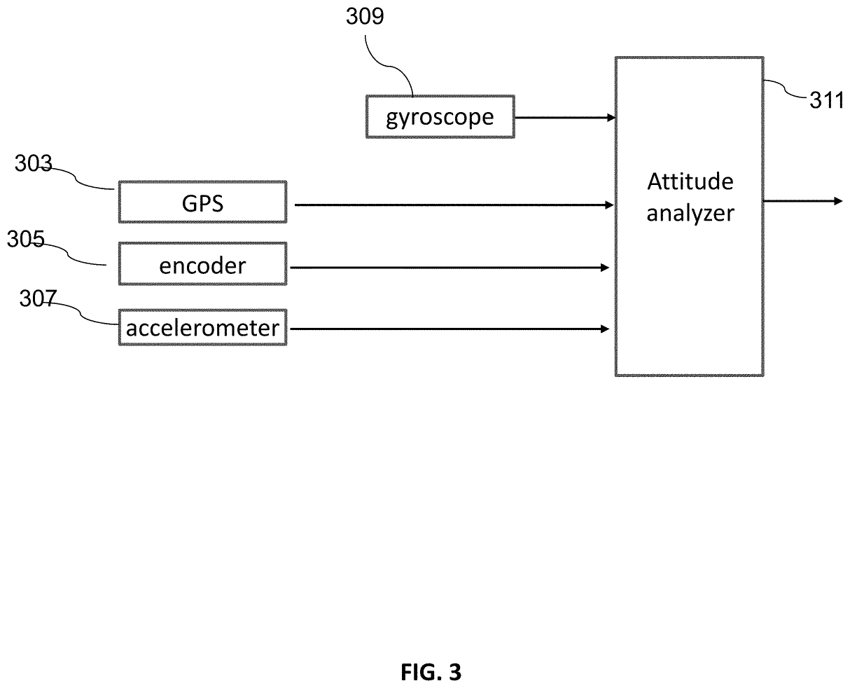

The corrected angular displacement based on the accelerometer and GPS may be further fused with other inertial sensors to obtain a corrected attitude data of the payload. FIG. 3 illustrates exemplary scheme for obtaining payload attitude data using the corrected accelerometer data and gyroscope. A plurality of sensors configured to measure an attitude of the payload may be located on a stabilizing unit. The stabilizing unit for supporting the payload may be the same as described in FIG. 1. In some embodiments, the attitude information of the payload may be measured by one or more accelerometers 307. The attitude information may be corrected based on a horizontal acceleration of the payload. In some cases, the attitude information may include at least a pitch and/or roll angular displacement. The horizontal acceleration may be obtained using one or more location sensors 303. It should be noted that any description of a GPS may apply to any type of location sensor or sensors used to measure location of the payload, and any description of an accelerometer may apply to any type of sensors that measure an attitude based on gravitational acceleration direction.

The accelerometer 307 may be located to the payload. The accelerometer may be located to the payload support of the stabilizing unit. The accelerometer may be located on any component or portion as long as such component has the same attitude as the payload. In some cases, the accelerometer may be part of an IMU. The accelerometer can be the same as described previously in FIG. 2. They attitude information about the payload may be detected by the accelerometer. The attitude information may include an angular displacement about a roll axis with respect to a ground reference frame. The attitude information may include an angular displacement about a pitch axis or both of a roll axis and pitch axis. The angular displacement may be corrected by compensating for a horizontal acceleration. As described previously, the horizontal acceleration can be obtained using a variety of sensors. In some cases, the horizontal acceleration can be obtained by one or more location sensors.

The location sensors 303 may be, for example, a GPS. The GPS may be used to measure location of the payload of the stabilizing unit with respect to an ground reference frame. Various technologies may be employed to improve precision of GPS measurement such as real time kinematics (RTK). A horizontal acceleration can be derived from the location or linear velocity detected by the GPS. The GPS may be located on the stabilizing unit. The GPS may be located on for example a frame portion of the stabilizing unit. GPS may be located on any portion of the stabilizing unit as long as the horizontal location of the payload can be detected by the GPS. In some embodiments, the GPS may be located on the frame assembly or the payload. In some embodiments, the GPS may be located with the inertial sensors. In some embodiments, the GPS may be located on the same frame component to which the inertial sensors are attached or the same payload. Alternatively, the GPS may be located on different frame component from the inertial sensors. The inertial sensors may have rotational movement relative to the GPS. In some cases, the rotational movement may be about a roll and/or pitch axis. The relative rotational movement may not result in a significant horizontal velocity discrepancy between the inertial sensors and the GPS. In some cases, a linear acceleration of the one or more inertial sensors can be derived based on the linear acceleration measured by the GPS using a transformation matrix. The transformation matrix may be used to convert the horizontal acceleration obtained by the GPS to the acceleration of the accelerometer. The transformation matrix may be obtained based on a known geometric or kinematics relationship (e.g., length of frame component, joint angle, etc) between the one or more inertial sensors and the GPS, and a relative rotational relationship between the inertial sensors and the GPS.

The transformation matrix may be obtained using one or more sensors that are configured to measure the rotational relationship between the inertial sensors and the GPS. In some cases, the relative rotational relationship can be obtained from one or more rotational sensors attached to the frame component. In some cases, one or more rotational sensors may be used to detect a rotational position. For example, rotational sensors such as encoders may be used to detect a relative angular position of the frame component relative to each other in the frame assembly, and the rotational relationship together with the dimension information may be used to derive the transformation matrix.

In some embodiments, the location sensor such as GPS and the inertial sensor such as accelerometer may have substantially the same translational acceleration, in which case the transformation matrix may represent a rotation from an initial reference frame (e.g., ground reference frame) to the current orientation of the inertial sensor/payload. In some cases, the matrix may be estimated based on one or more angular positional or angular motion sensors 305 coupled to the frame assembly. The angular positional or angular motion sensors may comprise at least a magnetic field sensor or an optical encoder. The angular positional sensor may be the same rotational sensors as described previously. The angular positional sensor may be, for example, an encoder (e.g., incremental encoder) that can measure a rotational position relative to an initial position. In some cases, when the initial position is aligned with a ground reference frame, the angular positional sensor may be able to track an orientation of the payload relative to the ground reference frame.

The one or more location sensors (e.g. GPS) and the one or more accelerometers may or may not have the same sampling frequency. In some cases, the location sensors may have lower sampling frequency compared to the accelerometer. In some embodiments, the attitude information collected by the accelerometer is corrected by the GPS data simultaneously. The attitude information collected by the accelerometer may be corrected at a variety of frequencies. The frequency may or may not depend on the sampling frequency of the GPS. The correction rate may or may not be constant. For example, when the payload is detected to be in a high dynamic movement, the correction frequency may be high.

In some embodiments, an attitude analyzer 311 may be configured to calculate a corrected attitude data. The corrected attitude data may be calculated based on the attitude information collected by one or more inertial sensors and a horizontal acceleration of the payload. In some cases, the one or more inertial sensors may include at least a gyroscope and an accelerometer. The attitude information collected by the accelerometer may be corrected by the one or more location sensors before fused with attitude information collected by the gyroscope 309 to achieve the attitude data of the payload. In some cases, the gyroscope and the accelerometer are components of an IMU.

The corrected attitude information from the accelerometer 307 and the location sensors may be fused with the attitude information collected by the gyroscope 309 using any suitable method. Other sensors that are capable of measuring attitude information or orientation information of the payload can also be used in conjunction with the accelerometer to provide the attitude data of the payload. In some cases, additional sensors such as magnetometers may also be used to obtain attitude data of the payload. The attitude data about the payload may include rotational angle of the payload with respect to up to three rotational axes. A variety of methods can be used to derive attitude data of the payload such as Kalman filter, Extended Kalman filter complimentary filter and various other sensor fusion algorithms. In some embodiments, at least one of the above filter is used for calculating the attitude data. In some cases, when the Kalman filter or extended Kalman filter is used, the corrected attitude information from the accelerometer may be used to date an estimation attitude angle provided by the gyroscope. In some cases, when the complimentary filter is used, the corrected attitude information from the accelerometer, attitude information from the gyroscope and the magnetometer may be weighted to derive the attitude data of the payload. In some cases, each type of sensor data may be individually pre-processed by one or more filters before fused to obtain the attitude data of the payload.

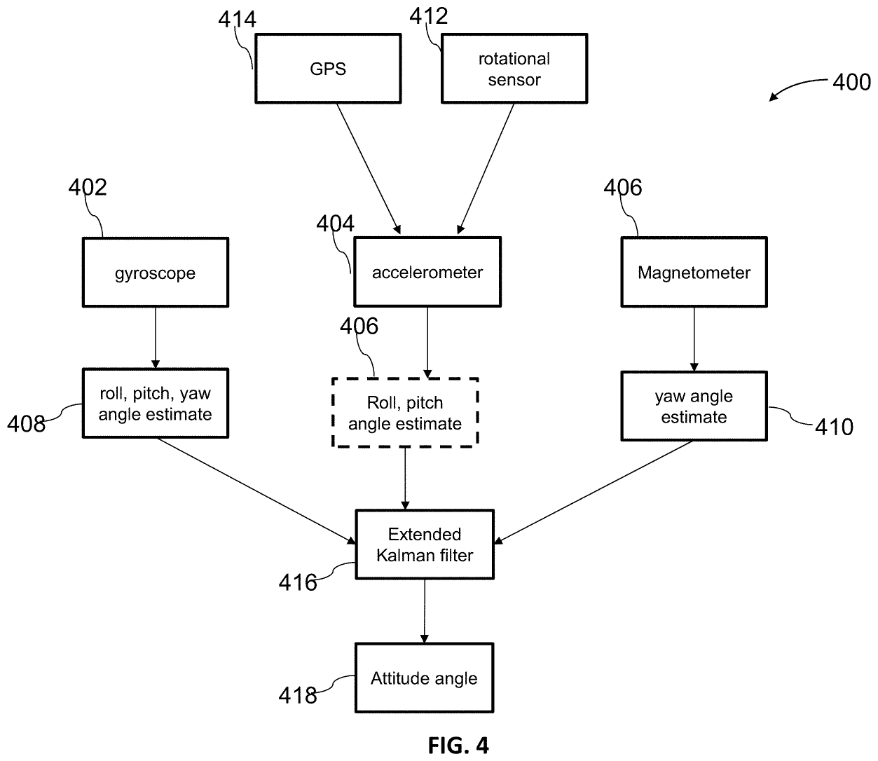

FIG. 4 illustrates a scheme 400 for estimating payload attitude using sensor fusion, in accordance with many embodiments. The scheme may employ an extended Kalman filter 416 as sensor fusion algorithm. A plurality of sensor data may be used to achieve attitude data of the payload. In some cases, the attitude data may include attitude angle 418 about one, two or three axes (e.g., roll axis, pitch axis, yaw axis). Various sensor data types may be fused in any combination and in any order. Two or more types of sensor data may be used to obtain the same attitude data. For example, sensor data with high sampling frequency (e.g., IMU) may be used to predict the state of the system and covariance, and the system state may be updated only when the low sampling frequency data (e.g., GPS) is available and stable. In another example, the gyroscope measurement may be used to calculate an attitude estimation during the prediction step, and once the Kalman gain is calculated, the corrected accelerometer data incorporated to aid the gyroscope measurement which both values are multiplied by the Kalman gain to use a percentage of each measurement based on their noise characteristics. Sensor data used for achieving each rotational angle may or may not be the same. In some cases, the same types of sensor data are used for rotational angles about each rotational axis. In some cases, sensor data for roll and pitch axes may not be the same for yaw axis. The scheme 400 utilizes one or more inertial sensors including one or more gyroscopes 402, one or more accelerometers 404, a GPS 414, a rotational sensor (angular position/angular motion sensor) (e.g. encoder) 412, and a magnetometer 406. The inertial sensors 402 and magnetometer 406 can be used to provide respective absolute estimates of the payload yaw angle, 408, 410. The inertial sensor (e.g., accelerometer) 404, location sensor (e.g., GPS) 414 and rotational sensors (e.g., encoders) 412 may provide roll and pitch angle estimate, and fuse with the roll and pitch angle data from the gyroscope. Any additional sensors may be incorporated to calculate the attitude angle, such as relative orientation sensors. The relative orientation sensors may include vision sensors, lidar, ultrasonic sensors, and time-of-flight or depth cameras. The relative orientation sensor data can be analyzed in order to provide an estimate of a yaw rate and relative yaw angle. Although the scheme shows only one extended Kalman filter, any number of filters may be used to obtain a final attitude angle. The combination of different types of measurement data may improve the accuracy of the final result 418. For example, in situations where the data provided by the accelerometer is corrupted (e.g., due to accelerated movement of the payload), the use of data from the GPS 414 and the encoder 412 can reduce the extent to which the accelerometer error influences the final result.

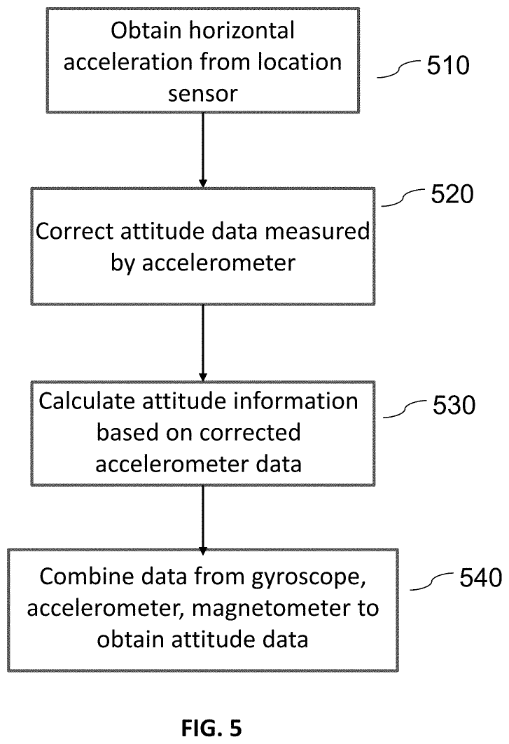

FIG. 5 illustrates a scheme of obtaining a corrected attitude data of the payload, in accordance with embodiments of the disclosure. The scheme can be used to obtain attitude data including rotational angles with respect to up to three axes (roll axis, pith axis and yaw axis). The attitude data can be achieved in real-time with improved accuracy. In the scheme, the horizontal acceleration with respect to a ground reference frame may be obtained from one or more location sensors 510. The one or more location sensors may include a GPS. Optionally, the horizontal acceleration can be obtained by various other sensors such as inertial sensors. The horizontal acceleration may be used for correcting the data measured from one or more accelerometers 520. In some cases, the horizontal acceleration may be eliminated from the acceleration measured by the accelerometer to obtain a gravitational acceleration. In some cases, the horizontal acceleration of the accelerometer may be calculated from the acceleration measured by the location sensors using a transformation matrix. The transformation matrix may be obtained using one or more angular position or angular motion such as magnetic field sensors or optical encoders. The one or more angular position or angular motion sensors may be coupled to one or more actuators of the stabilizing unit recording rotational movement of the frame components of the stabilizing unit. Once the accelerometer data are corrected, the attitude information about the payload may be calculated based on a gravitational vector. The attitude information may include rotational angle about a roll axis and/or pitch axis 530. The attitude information may be further fused with attitude information from other sensors such as gyroscopes, magnetometers to obtain attitude data of the payload 540. As described previously, any suitable algorithms can be used to calculate the attitude data based on the various sensor data.

In some embodiments, the corrected attitude data can be used for controlling an attitude of the payload supported by the stabilizing unit. One or more actuators may be configured to effect movement of a plurality of frame components to control attitude of the payload. In some embodiments, the stabilizing unit may comprise one or more processors for controlling the one or more actuators to change the attitude of the payload based on the corrected attitude data. The one or more processors may be individually or collectively configured to determine, based on a target angle, an input torque to be provided from the one or more actuators to the one or more frame components of the stabilizing unit. In some cases, the input torque may be determined using a feedback control loop.

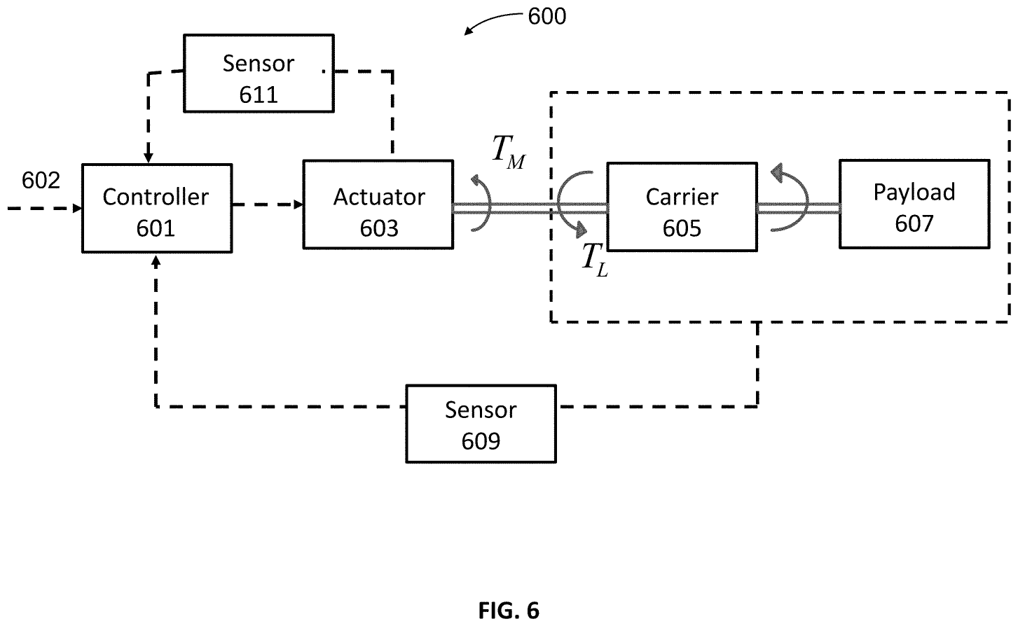

FIG. 6 illustrates an example of a system 600 for controlling or stabilizing a rotational movement of a payload with respect to one or more axes, in accordance with some embodiments. The system 600 can include a controller 601, one or more actuator 603, a carrier 605, one or more sensors 609 and 611, and a payload 607. In some embodiments, the carrier 605 may be a three-axis gimbal platform. Alternatively, the carrier can be one or two-axis gimbal platform. The carrier may comprise one or more frame components.

In some embodiments, controlling the carrier may comprise effecting movement of the one or more frame components based in part on the detected attitude data of the payload. In some embodiments, the movement of the carrier may comprise an angular position, an angular velocity, an/or an angular acceleration of the carrier. In some embodiments, the movement of the carrier is effected relative to an inertial reference frame such as the ground. For example, the payload may be stabilized or leveled by the carrier with respect to the ground.

As described above and herein, the carrier 605 can be used to control the spatial disposition of a coupled payload. For instance, the carrier can be used to rotate the payload to a desired spatial disposition. The desired spatial disposition can be manually input by a user (e.g., via remote terminal or other external device in communication with the movable object, carrier, and/or payload), determined autonomously without requiring user input (e.g., by one or more processors of the movable object, carrier, and/or payload), or determined semi-autonomously with aid of one or more processors of the movable object, carrier, and/or payload. The desired spatial disposition can be used to calculate a movement of the carrier or one or more components thereof (e.g., one or more frames) that would achieve the desired spatial disposition of the payload.

For example, in some embodiments, an input angle 602 (e.g., a roll angle for level the payload) associated with a desired attitude of the payload is received by a controller (e.g., of the movable object, carrier, and/or payload). The input angle may be provided by user or autonomous such as a stabilizing angle relative to a fixed reference frame as previously described. Based on the input angle, the controller may comprise one or more processors that can determine an output torque to be applied to the carrier or one or more components thereof (e.g., a yaw frame) in order to achieve the desired attitude. The output torque can be determined in a variety of ways, such as using a controller 601. In some embodiments, a feedback control loop may be used to control the movement of the carrier. The feedback control loop can take the input angle as an input and output the output torque as an output. The feedback control loop can be implemented using one or more of a proportional (P) controller, a proportional-derivative (PD) controller, a proportional-integral (PI) controller, a proportional-integral-derivative (PID) controller, or combinations thereof.

In some embodiments, the actuator(s) 603 may be one or more motors. The motor may or may not be a DC servo motor. In some embodiments, a speed control of the motor may be carried out by changing the supply voltage of the motor. Various other types of motors can be used as described previously in FIG. 1.

In some embodiments, the attitude information about the payload may be obtained using one or more sensors 609. The one or more sensors may be located on the carrier or the payload. The one or more sensors may include one or more inertial sensors and location sensors. The location sensors may include a GPS for obtaining a horizontal acceleration of the payload. The horizontal acceleration may be used for correcting the attitude information collected from the one or more inertial sensors. In some embodiments, the one or more sensors can collectively constitute an inertial measurement unit (IMU). In other embodiments, the one or more sensor may include at least a gyroscope used for measuring an angular velocity of the carrier and an accelerometer for measuring attitude information of the payload. However, any type of sensors may be used dependent on the variables to be controlled in the system.

The sensor(s) 609 may include any sensor suitable for obtaining data indicative of a spatial disposition (e.g., position, orientation, angle) and/or motion characteristic (e.g., translational (linear) velocity, angular velocity, translational (linear) acceleration, angular acceleration) of a payload, such as an inertial sensor. In some cases, the sensor(s) may include at least an inertial sensor and at least a location sensor. Sensory data collected from the location sensor may be used to correct the attitude data measured by the inertial sensor to achieve an improved accuracy of attitude measurement. An inertial sensor may be used herein to refer to a motion sensor (e.g., a velocity sensor, an acceleration sensor such as an accelerometer), an orientation sensor (e.g., a gyroscope, inclinometer), or an IMU having one or more integrated motion sensors and/or one or more integrated orientation sensors. An inertial sensor may provide sensing data relative to a single axis of motion. The axis of motion may correspond to an axis of the inertial sensor (e.g., a longitudinal axis). A plurality of inertial sensors can be used, with each inertial sensor providing measurements along a different axis of motion. For example, three angular accelerometers can be used to provide angular acceleration data along three different axes of motion. The three directions of motion may be orthogonal axes. One or more of the angular accelerometers may be configured to measure acceleration around a rotational axis. As another example, three gyroscopes can be used to provide orientation data about three different axes of rotation. The three axes of rotation may be orthogonal axes (e.g., roll axis, pitch axis, yaw axis). Alternatively, at least some or all of the inertial sensors may provide measurement relative to the same axes of motion. Such redundancy may be implemented, for instance, to improve measurement accuracy. Optionally, a single inertial sensor may be capable of providing sensing data relative to a plurality of axes. For example, an IMU including a plurality of accelerometers and gyroscopes can be used to generate acceleration data and orientation data with respect to up to six axes of motion. The attitude data collected by the IMU may be corrected using the location sensor data (e.g., GPS) as described elsewhere herein.

The sensor(s) 609 can be carried by the carrier. The sensor can be situated on any suitable portion of the carrier, such as above, underneath, on the side(s) of, or within a body of the carrier. The sensor(s) can be located on the frame or a support portion of the carrier. Some sensors can be mechanically coupled to the carrier such that the spatial disposition and/or motion of the carrier correspond to the spatial disposition and/or motion of the sensors. The sensor can be coupled to the carrier via a rigid coupling, such that the sensor does not move relative to the portion of the carrier to which it is attached. The coupling can be a permanent coupling or non-permanent (e.g., releasable) coupling. Suitable coupling methods can include adhesives, bonding, welding, and/or fasteners (e.g., screws, nails, pins, etc.). Optionally, the sensor can be integrally formed with a portion of the payload. Furthermore, the sensor can be electrically coupled with a portion of the payload (e.g., processing unit, control system, data storage). In some cases, the sensor(s) may comprise a plurality of sensors all of which are located on the frame components. In some cases, the sensor(s) are located on the payload. In some cases, some of the sensors are located on the payload whereas other located on the components of the carrier.

In some embodiments, the rotational angle of the motor may be obtained using one or more sensor(s) 611 located on the motor. For example, the sensor(s) 611 may be located on an output shaft of the motor and configured to measure the angular acceleration of the motor such as an encoder or angular potentiometer. The rotational angle of the motors may be used to obtain a relative rotation from an inertial reference frame or initial position to an accelerometer body frame or current orientation of the payload. The sensor(s) may be the same angular positional or angular motion sensors as described elsewhere herein.

The controller 601 may comprise one or more processors for processing the various sensor data to obtain the corrected attitude data of the payload. In response to the attitude data, the one or more processors may provide input signal to the one or more actuators for stabilizing the payload in a desired orientation.

Regarding the control system, cascaded proportional-integral-derivative (PID) may be used to control the attitude and velocity of the carrier. It should be noted that there are a variety of control algorithms can be used to control a gimbal or carrier system, including but not limited to: ON-OFF, PID modes, feedforward, adaptive, intelligent (Fuzzy logic, Neural network, Expert Systems and Genetic) control algorithms. For a specific control model such as PID control, based on various control objective/output variable (e.g., angular velocity, angular position, angular acceleration, torque, etc) to be controlled and the input variable (e.g. input voltage) the control system can be different. Accordingly, control parameters may be represented in various ways. However, the presented method and system provides a controller adapt to various payloads automatically independent of how the system is represented mechanically and/or mathematically.

The corrected attitude data can be used for controlling an attitude of the payload supported by the stabilizing unit. The corrected attitude data of the payload can be used for various other purposes. For example, when the payload comprises an imaging device, the corrected attitude data may be used for image processing such as image stabilization.

In some embodiments, one or more processors may be configured to calculate the corrected attitude data of the payload. In some embodiments, the one or more processors may be a programmable processor (e.g., a central processing unit (CPU) or a microcontroller), a field programmable gate array (FPGA) and/or one or more ARM processors. In some embodiments, the one or more processors may be operatively coupled to a non-transitory computer readable medium. The non-transitory computer readable medium can store logic, code, and/or program instructions executable by the one or more processors unit for performing one or more steps. The non-transitory computer readable medium can include one or more memory units (e.g., removable media or external storage such as an SD card or random access memory (RAM)).

In some embodiments, the one or more location sensors for detecting a location of the payload with respect to a world reference frame may be removably attached to a portion of the stabilizing unit or the payload. The location sensor(s) may comprise a GPS. The location sensor (s) may be attached to a variety of locations of the stabilizing unit such as the one or more frame components of the frame assembly of the stabilizing unit. In some cases, the location sensor(s) may be located with the payload.

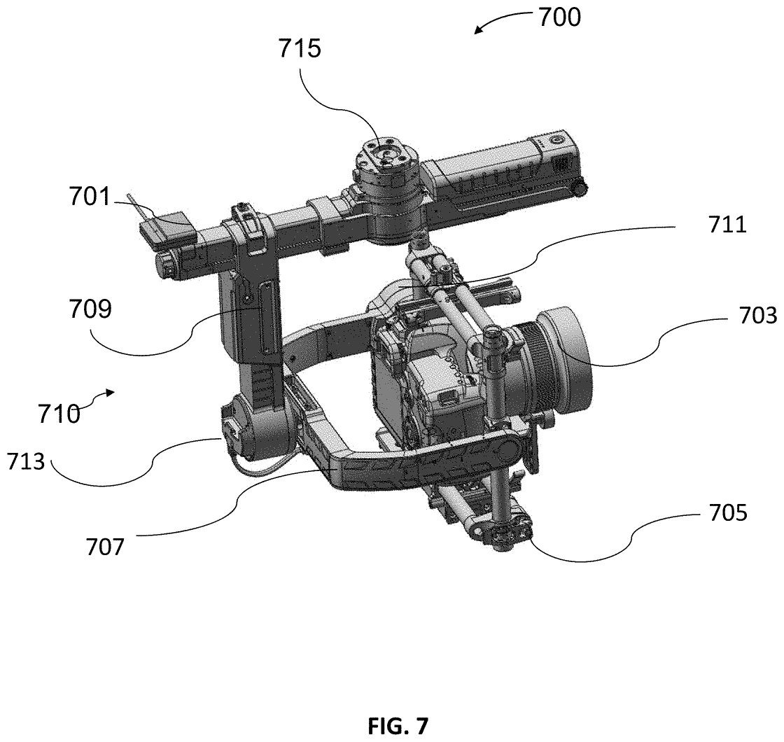

FIG. 7 illustrates an example of an apparatus for stabilizing a payload, in accordance with embodiments of the disclosure. The elements of the apparatus 700 can be used in combination with any of the systems, devices, and methods described herein. The apparatus 700 can be carried by a movable object (not shown), such as a living subject, a vehicle, a UAV, etc. The apparatus 700 can be a hand-held device carried by a human. The apparatus 700 includes a carrier which is coupled to the payload 703. The apparatus may include a location sensor 701 located on a portion of the apparatus.

In the depicted embodiment 700, the carrier 710 includes a first frame 705 affixed to the payload 703 and a second frame 707 coupled to the first frame 705. In the depicted embodiment 700, the third frame 709 is a yaw frame that is actuated by a yaw actuator 715 in order to rotate the carrier 710 and coupled payload 710 about a yaw axis, and the first frame 705 is a pitch frame that is actuated by a pitch actuator 711 in order to rotate the carrier 710 and coupled payload 703 about a pitch axis. The carrier 710 can also include a roll actuator 713 configured to rotate the payload 703 about a roll axis. The actuators 711, 713, and 715 can each apply a torque to rotate the respective frame or payload about the corresponding axis of rotation. Each actuator can be a motor including a rotor and a stator. For instance, the yaw actuator 715 can include a rotor coupled to the yaw frame (third frame 709) and a stator coupled to the movable object (not shown), or vice-versa. However, it shall be appreciated that alternative configurations of the carrier can also be used (e.g., less than or more than two frames, the second frame 707 may be a pitch frame or a yaw frame rather than a roll frame, the first frame may be a yaw frame or a roll frame rather than a pitch frame, etc.). In some cases, as described elsewhere herein, the carrier may comprise a spherical motor such that the all the three rotational axes may intersect at a center of the spherical motor.

In some embodiments, one or more location sensors may be located on the carrier to measure a horizontal velocity or location as previously described herein. The one or more location sensors 701 can be the same location sensors as described in FIG. 1. The location sensors may be installed on any suitable position on the carrier such as the frame component 709, in which case the location sensors may have a rotational movement relative to the movable object. The location sensor could be on the first frame, the second frame and/or the third frame component. For instance, the location sensor may be located on a yaw frame such that the location sensors may rotate about a yaw axis relative to the movable object. The location sensor can be placed on other portions of the frame component or on other frame components such as the second frame 707 or the first frame 705. The transformation matrix may vary according to a relative position and movement of the accelerometers to the location sensor. The transformation matrix may represent a translational and rotational movement between the accelerometers and the location sensor, and the transformation matrix may be obtained based on dimensional and rotational information as described previously herein. For instance, the transformation matrix may be different when the location sensor located on different frames, or different location on the same frame.

In some cases, the location sensor may be situated on a location with less rapid movement along a vertical direction. For example, the location sensor may be located on a frame component configured to rotate about a yaw axis relative to a ground reference frame. In this case, the movement detected by the location sensor may be substantially a lateral movement of the stabilizing unit in the horizontal plane.

As discussed above and herein, the carrier can be used to control the spatial disposition (e.g., position and/or orientation) of a coupled payload. For instance, the carrier can be used to stabilize the payload with respect to a ground surface. The payload may be for example leveled with the ground surface such that a tilting or rolling movement caused by the movable object can be mitigated by the carrier. In another instance, the carrier can be used to move (e.g., translate and/or rotate) the payload to a desired spatial disposition. The desired spatial disposition can be manually input by a user (e.g., via remote terminal or other external device in communication with the movable object, carrier, and/or payload), determined autonomously without requiring user input (e.g., by one or more processors of the movable object, carrier, and/or payload), or determined semi-autonomously with aid of one or more processors of the movable object, carrier, and/or payload. The desired spatial disposition can be used to calculate a movement of the carrier or one or more components thereof (e.g., one or more frames) that would achieve the desired spatial disposition of the payload.

For example, in some embodiments, an input angle (e.g., a roll angle) associated with a desired attitude of the payload is received by one or more processors (e.g., of the movable object, carrier, and/or payload). Based on the input angle, the one or more processors can determine an output torque to be applied to the carrier or one or more components thereof (e.g., a roll frame) in order to achieve the desired attitude. The output torque can be determined in a variety of ways, such as using a feedback control loop. The feedback control loop can take the input angle as an input and output the output torque as an output. The feedback control loop can be implemented using one or more of a proportional (P) controller, a proportional-derivative (PD) controller, a proportional-integral (PI) controller, a proportional-integral-derivative (PID) controller, or combinations thereof.

One or more processors may be provided to determine the attitude data of the payload using the method provided herein. The attitude data may be corrected for a horizontal movement of the carrier. The corrected attitude data may be calculated with aid of one or more processors. In some cases, the one or more processors may be on-board the stabilizing unit. In some cases, the one or more processors may be remote to the stabilizing unit.

The carrier or gimbal may be one-axis gimbal system or multi-axis gimbal system. One or more sensor may be included to measure the motion of the carrier. The sensor(s) can be any sensor suitable for obtaining data indicative of a spatial disposition (e.g., position, orientation, angle) and/or motion characteristic (e.g., translational (linear) velocity, angular velocity, translational (linear) acceleration, angular acceleration) of a payload, such as an inertial sensor. An inertial sensor may be used herein to refer a motion sensor (e.g., a velocity sensor, an acceleration sensor such as an accelerometer), an orientation sensor (e.g., a gyroscope, inclinometer), or an IMU having one or more integrated motion sensors and/or one or more integrated orientation sensors. An inertial sensor may provide sensing data relative to a single axis of motion. The axis of motion may correspond to an axis of the inertial sensor (e.g., a longitudinal axis). A plurality of inertial sensors can be used, with each inertial sensor providing measurements along a different axis of motion. For example, three accelerometers can be used to provide acceleration data along three different axes of motion. The three directions of motion may be orthogonal axes. One or more of the accelerometers may be linear accelerometers configured to measure acceleration along a translational axis. Conversely, one or more of the accelerometers may be angular accelerometers configured to measure angular acceleration around a rotational axis. As another example, three gyroscopes can be used to provide orientation data about three different axes of rotation. The three axes of rotation may be orthogonal axes (e.g., roll axis, pitch axis, yaw axis). Alternatively, at least some or all of the inertial sensors may provide measurement relative to the same axes of motion. Such redundancy may be implemented, for instance, to improve measurement accuracy. Optionally, a single inertial sensor may be capable of providing sensing data relative to a plurality of axes. For example, an IMU including a plurality of accelerometers and gyroscopes can be used to generate acceleration data and orientation data with respect to up to six axes of motion. Alternatively, a single accelerometer can be used to detect acceleration along multiple axes, and a single gyroscope can be used to detect rotation about multiple axes.

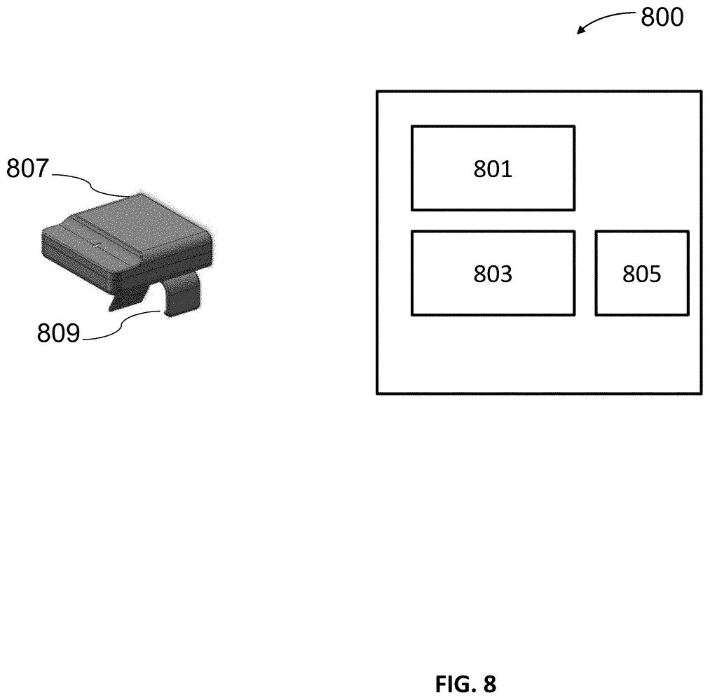

In some embodiments, the location sensors may comprise a GPS that is enclosed in a housing. FIG. 8 shows a modular location sensor 800 configured to be releasably attached to a portion of the frame assembly, in accordance with embodiments of the disclosure. The location sensor module 800 may comprise a housing 807. The housing may comprise structures 809 for coupling the sensor module to a portion of the frame assembly or the payload. The sensor module may comprise the same location sensors as described elsewhere herein. The coupling may or may not require tool. The modular location sensor may be repeatedly attached to and detached from a stabilizing unit to improve the accuracy of attitude data as described elsewhere. In some cases, the modular location sensor may be interchangeable between different stabilizing units. In some cases, a single modular location sensor could be attached to different stabilizing units. In some cases, different modular location sensors could be alternatively attached to the same stabilizing unit. In some cases, the coupling structure 809 may provide a quick attachment (e.g., clip, fastener, etc) to a frame component. In some cases, the housing may be attached to a predetermined location on the frame assembly or the payload such that the dimensional or rotational information between the location sensor and the inertial sensor is known to the system. In other cases, the housing may be attached to a variety of locations that the relative location between the location sensor and the inertial sensor is not required by the system. The location sensor module 800 may comprise one or more location sensors 801, a power unit 803 and data transmission element 805. The one or more location sensors 801 may comprise a GPS unit. Various technologies may be employed to improve precision of GPS measurement such as real time kinematics (RTK). In some cases, the housing may further comprise one or more inertial sensors for collecting attitude information about the payload. In some cases, the location sensor module may be located at a different location on the stabilizing unit from the one or more inertial sensors.

The one or more sensors may comprise any suitable sensor that is capable to measure a horizontal linear velocity, location or linear acceleration of the payload. For instance, instead of GPS, motion sensors such as IMU or vision sensors such as binocular vision sensors or monocular visual odometry (MVO) may also be used to obtain the horizontal acceleration. Optionally, two or more sensors may be used collectively to produce the horizontal acceleration. For instance, a fusion of GPS data and visional sensors data or IMU data may be used to produce the horizontal acceleration. In another instance, more than one GPS units may be used to measure the horizontal velocity. In some cases, at least a portion of the sensors configured to detect a horizontal movement (e.g., location, velocity) of the payload are enclosed in the housing, whereas the rest of the sensors may be located at a different location. For instance, when two GPS are used to produce, one of the GPS may be enclosed in the housing and the other GPS may be provided on the payload or on the movable object/living subject. In some cases, when two or more different types of sensors are configured to provide a horizontal acceleration, the sensor data may be cross-checked for validity or quality before being fused to calculate the horizontal acceleration. In some cases, different sensors for detecting the horizontal movement may be used according to certain conditions such as sensor data availability, quality of sensor data, environmental conditions, etc. For instance, vision sensors may be used when the GPS data are not available, or GPS data may be used when the illumination of the environment or key features in a view are not good enough to achieve quality vision data. Various threshold or criteria may be employed to decide the selection of sensor data to be used. The threshold or criteria may be determined based on empirical information, experimental information, simulations, etc.

In some cases, the power unit 803 may be an autonomous source power (e.g., battery) enclosed in the housing. Alternatively, the sensor module may be powered by an external device (e.g., the stabilizing unit, movable object, etc).

In some cases, the one or more location sensors are configured to transmit the location data wireless. The some cases, the transmission element 805 may be configured to transmit sensor data to one or more processors of the stabilizing unit. Any suitable means can be utilized for data transmission. For example, wired communication (e.g., inter-integrated circuit (I2C)) buses may be provided for data transmission. It is noted that any type and any number of wired communication buses such as I2C or serial peripheral interface (SPI) or wireless communication means (e.g., Bluetooth, Wi-Fi) can be used to accomplish data transmission. Selection of various means for transmitting data may be determined based on need of speed for transmission and bandwidth requirement. Location data and/or velocity data collected by the location sensors may be provided to the one or more processors for correcting attitude data of the payload.

In some embodiments, the stabilizing unit may comprise a mounting assembly to allow the stabilizing unit switch from mounting to one movable object to another movable object. In some embodiments, the relative movement between the carrier and the movable object may not be actively controlled. For example, when the stabilizing unit is carried by a human being or coupled to a movable object without attitude information, the attitude of the payload may be stabilized relative to an inertial reference frame regardless of the movement of the movable object. In some embodiments, the relative movement between the carrier and the movable object may be actively controlled. For example, when the movable object is a UAV, the movement of the stabilizing unit may be controlled based on both attitude data collected from sensors on the UAV and attitude data collected from sensors on the payload. In some cases, horizontal acceleration used for correcting the attitude data of the payload may be provided by sensors on-board the UAV. The control mechanism may or may not be the same when the stabilizing unit is attached to movable objects with and without sensors for attitude measurement.

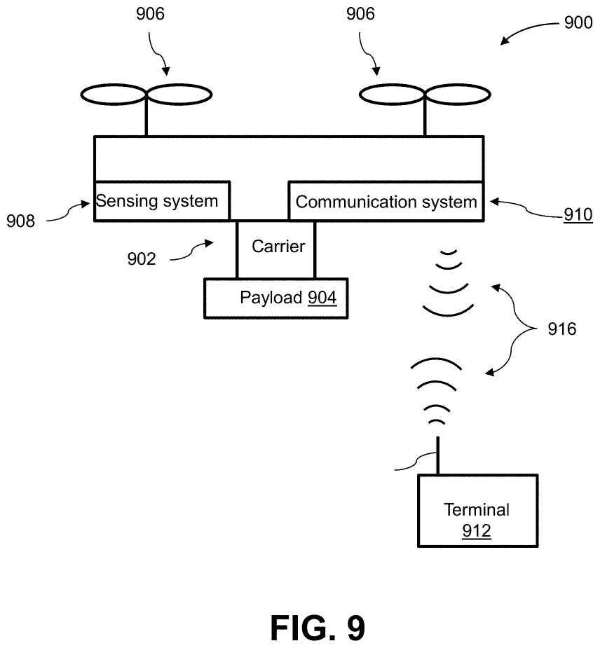

FIG. 9 illustrates a movable object 900 including a carrier 902 and a payload 904, in accordance with embodiments. Although the movable object 900 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 904 may be provided on the movable object 900 without requiring the carrier 902. The movable object 900 may include propulsion mechanisms 906, a sensing system 908, and a communication system 910.

The propulsion mechanisms 906 can include one or more of rotors, propellers, blades, engines, motors, wheels, axles, magnets, or nozzles, as previously described. For example, the propulsion mechanisms 906 may be self-tightening rotors, rotor assemblies, or other rotary propulsion units, as disclosed elsewhere herein. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 906 can be mounted on the movable object 900 using any suitable means, such as a support element (e.g., a drive shaft) as described elsewhere herein. The propulsion mechanisms 906 can be mounted on any suitable portion of the movable object 900, such on the top, bottom, front, back, sides, or suitable combinations thereof.

In some embodiments, the propulsion mechanisms 906 can enable the movable object 900 to take off vertically from a surface or land vertically on a surface without requiring any horizontal movement of the movable object 900 (e.g., without traveling down a runway). Optionally, the propulsion mechanisms 906 can be operable to permit the movable object 900 to hover in the air at a specified position and/or orientation. One or more of the propulsion mechanisms 900 may be controlled independently of the other propulsion mechanisms. Alternatively, the propulsion mechanisms 900 can be configured to be controlled simultaneously. For example, the movable object 900 can have multiple horizontally oriented rotors that can provide lift and/or thrust to the movable object. The multiple horizontally oriented rotors can be actuated to provide vertical takeoff, vertical landing, and hovering capabilities to the movable object 900. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 900 (e.g., with respect to up to three degrees of translation and up to three degrees of rotation).

The sensing system 908 can include one or more sensors that may sense the spatial disposition, velocity, and/or acceleration of the movable object 900 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 908 can be used to control the spatial disposition, velocity, and/or orientation of the movable object 900 (e.g., using a suitable processing unit and/or control module, as described below). Alternatively, the sensing system 908 can be used to provide data regarding the environment surrounding the movable object, such as weather conditions, proximity to potential obstacles, location of geographical features, location of manmade structures, and the like.

The communication system 910 enables communication with terminal 912 having a communication system 914 via wireless signals 916. The communication systems 910, 914 may include any number of transmitters, receivers, and/or transceivers suitable for wireless communication. The communication may be one-way communication, such that data can be transmitted in only one direction. For example, one-way communication may involve only the movable object 900 transmitting data to the terminal 912, or vice-versa. The data may be transmitted from one or more transmitters of the communication system 910 to one or more receivers of the communication system 912, or vice-versa. Alternatively, the communication may be two-way communication, such that data can be transmitted in both directions between the movable object 900 and the terminal 912. The two-way communication can involve transmitting data from one or more transmitters of the communication system 910 to one or more receivers of the communication system 914, and vice-versa.

In some embodiments, the terminal 912 can provide control data to one or more of the movable object 900, carrier 902, and payload 904 and receive information from one or more of the movable object 900, carrier 902, and payload 904 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 906), or a movement of the payload with respect to the movable object (e.g., via control of the carrier 902). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 908 or of the payload 904). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 912 can be configured to control a state of one or more of the movable object 900, carrier 902, or payload 904. Alternatively or in combination, the carrier 902 and payload 904 can also each include a communication module configured to communicate with terminal 912, such that the terminal can communicate with and control each of the movable object 900, carrier 902, and payload 904 independently.

In some embodiments, the movable object 900 can be configured to communicate with another remote device in addition to the terminal 912, or instead of the terminal 912. The terminal 912 may also be configured to communicate with another remote device as well as the movable object 900. For example, the movable object 900 and/or terminal 912 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 900, receive data from the movable object 900, transmit data to the terminal 912, and/or receive data from the terminal 912. Optionally, the remote device can be connected to the Internet or other telecommunications network, such that data received from the movable object 912 and/or terminal 912 can be uploaded to a website or server.

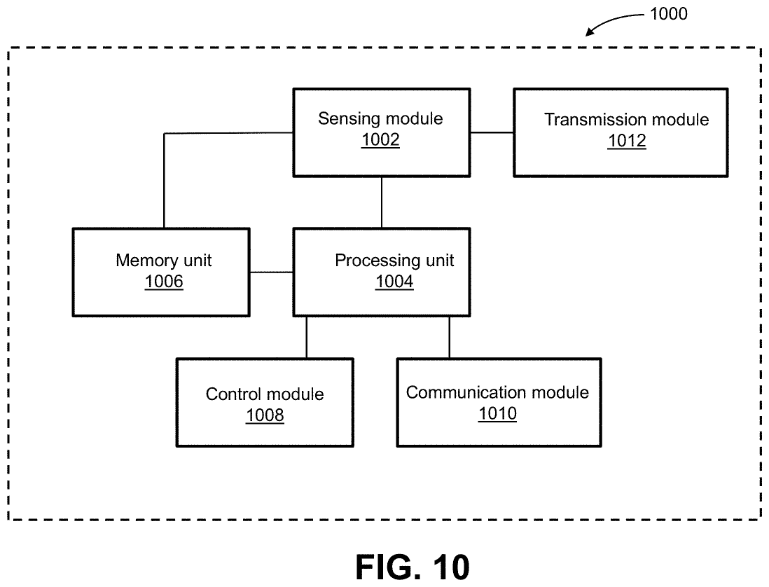

FIG. 10 is a schematic illustration by way of block diagram of a system 1000 for controlling a movable object, in accordance with embodiments. The system 1000 can be used in combination with any suitable embodiment of the systems, devices, and methods disclosed herein. The system 1000 can include a sensing module 1002, processing unit 1004, non-transitory computer readable medium 1006, control module 1008, and communication module 1010.

The sensing module 1002 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1002 can be operatively coupled to a processing unit 1004 having a plurality of processors. In some embodiments, the sensing module can be operatively coupled to a transmission module 1012 (e.g., a Wi-Fi image transmission module) configured to directly transmit sensing data to a suitable external device or system. For example, the transmission module 1012 can be used to transmit images captured by a camera of the sensing module 1002 to a remote terminal.

The processing unit 1004 can have one or more processors, such as a programmable processor (e.g., a central processing unit (CPU)). The processing unit 1004 can be operatively coupled to a non-transitory computer readable medium 1006. The non-transitory computer readable medium 1006 can store logic, code, and/or program instructions executable by the processing unit 1004 for performing one or more steps. The non-transitory computer readable medium can include one or more memory units (e.g., removable media or external storage such as an SD card or random access memory (RAM)). In some embodiments, data from the sensing module 1002 can be directly conveyed to and stored within the memory units of the non-transitory computer readable medium 1006. The memory units of the non-transitory computer readable medium 1006 can store logic, code and/or program instructions executable by the processing unit 1004 to perform any suitable embodiment of the methods described herein. For example, the processing unit 1004 can be configured to execute instructions causing one or more processors of the processing unit 1004 to analyze sensing data produced by the sensing module. The memory units can store sensing data from the sensing module to be processed by the processing unit 1004. In some embodiments, the memory units of the non-transitory computer readable medium 1006 can be used to store the processing results produced by the processing unit 1004.

In some embodiments, the processing unit 1004 can be operatively coupled to a control module 1008 configured to control a state of the movable object. For example, the control module 1008 can be configured to control the propulsion mechanisms of the movable object to adjust the spatial disposition, velocity, and/or acceleration of the movable object with respect to six degrees of freedom. Alternatively or in combination, the control module 1008 can control one or more of a state of a carrier, payload, or sensing module.

The processing unit 1004 can be operatively coupled to a communication module 1010 configured to transmit and/or receive data from one or more external devices (e.g., a terminal, display device, or other remote controller). Any suitable means of communication can be used, such as wired communication or wireless communication. For example, the communication module 1010 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1010 can transmit and/or receive one or more of sensing data from the sensing module 1002, processing results produced by the processing unit 1004, predetermined control data, user commands from a terminal or remote controller, and the like.

The components of the system 1000 can be arranged in any suitable configuration. For example, one or more of the components of the system 1000 can be located on the movable object, carrier, payload, terminal, sensing system, or an additional external device in communication with one or more of the above. Additionally, although FIG. 10 depicts a single processing unit 1004 and a single non-transitory computer readable medium 1006, one of skill in the art would appreciate that this is not intended to be limiting, and that the system 1000 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 1000 can occur at one or more of the aforementioned locations.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

What is claimed is:

1. A stabilizing unit for controlling an attitude of a payload comprising:
a frame assembly comprising a plurality of frame components movable relative to one another, wherein the frame assembly is configured to support the payload;
a base support configured to couple the frame assembly to a movable object;
one or more inertial sensors attached to the frame assembly or the payload, wherein the one or more inertial sensors are configured to collect attitude information of the payload about a plurality of rotational axes;
one or more location sensors attached to (1) the base support, or (2) one or more of the plurality of frame components of the frame assembly, wherein the one or more location sensors are configured to collect location data;
one or more actuators configured to control movement of the plurality of frame components; and
one or more processors configured to control the attitude of the payload based on corrected attitude data by controlling the one or more actuators, wherein the corrected attitude data is calculated based on the attitude information collected by the one or more inertial sensors and a horizontal acceleration of the payload that is determined based on the location data.

2. The stabilizing unit of claim 1, wherein the one or more location sensors comprise a GPS unit.

3. The stabilizing unit of claim 1, wherein the one or more location sensors are disposed at one or more locations on the stabilizing unit that are different from the one or more inertial sensors.

4. The stabilizing unit of claim 1, wherein the one or more location sensors are configured to measure a horizontal motion of the payload or the one or more inertial sensors.

5. The stabilizing unit of claim 4, wherein the horizontal motion is relative to a ground reference frame.

6. The stabilizing unit of claim 1, wherein said one or more location sensors are configured to detect at least one of a position, linear velocity, or linear acceleration of the payload or the one or more inertial sensors.

7. The stabilizing unit of claim 1, further comprising one or more angular positional sensors coupled to the frame components and configured to detect an angular position of the one or more actuators.

8. The stabilizing unit of claim 1, wherein:
the one or more inertial sensors include a plurality of inertial sensors; and
the corrected attitude data is determined by (a) measuring a direction of a gravitational vector by a first set of the plurality of inertial sensors, (b) correcting the measured direction of the gravitational vector with the horizontal acceleration of the payload to obtain a corrected direction of the gravitational vector, and (c) fusing sensor data measured by a second set of the plurality of inertial sensors with the corrected direction of the gravitational vector.

9. The stabilizing unit of claim 8, wherein the first set of the plurality of inertial sensors includes an accelerometer.

10. The stabilizing unit of claim 9, wherein the horizontal acceleration is subtracted from the gravitational vector to correct the measured direction of the gravitational vector.

11. The stabilizing unit of claim 10, wherein the horizontal acceleration is with respect to an accelerometer body reference frame and is obtained based on a transformation matrix and a measured horizontal acceleration measured by the one or more location sensors.

12. The stabilizing unit of claim 11, wherein the transformation matrix is based on a relative movement between the accelerometer and the one or more location sensors measured by one or more angular positional sensors coupled to the frame assembly.

13. The stabilizing unit of claim 11, wherein an estimated rotation matrix is used to transform the horizontal acceleration to the accelerometer body reference frame.

14. The stabilizing unit of claim 13, wherein the estimated rotation matrix is based on one or more angular positional sensors coupled to the frame assembly.

15. The stabilizing unit of claim 1, wherein the stabilizing unit is a multi-axis gimbal further comprising one or more angular motion sensors and/or angular positional sensors attached to the frame assembly.

16. The stabilizing unit of claim 15, wherein the one or more processors are individually or collectively configured to determine, based on a target angle, an input torque to be provided from the one or more actuators to the one or more of the plurality of frame components of the gimbal.

17. The stabilizing unit of claim 16, wherein the input torque is determined using a feedback control loop.

18. The stabilizing unit of claim 1, wherein the payload comprises an imaging device.

19. The stabilizing unit of claim 1, wherein the one or more location sensors are enclosed in a housing.

20. The stabilizing unit of claim 19, wherein the housing is releasably coupled to a portion of the one or more of the plurality of frame components of the frame assembly, or the payload.

21. The stabilizing unit of claim 1, wherein the one or more location sensors are configured to transmit the location data wirelessly.
